(19) United States
(12) Patent Application Publication
(10) Pub. No.: US 2026/0063484 A1
(43) Pub. Date: Mar. 5, 2026

(54) SENSING MODULE

(71) Applicant: Coretronic Corporation, Hsin-Chu (TW)

(72) Inventors: Huai-Chung Hsu, Hsin-Chu (TW); Chih-Jen Tsang, Hsin-Chu (TW); Chia-Hua Chen, Hsin-Chu (TW); Bo-Chih Pan, Hsin-Chu (TW); Shang-Hsuang Wu, Hsin-Chu (TW)

(73) Assignee: Coretronic Corporation, Hsin-Chu (TW)

(21) Appl. No.: 19/294,293

(22) Filed: Aug. 8, 2025

(30) Foreign Application Priority Data
Sep. 4, 2024 (CN) 202411231989.7

(51) Int. Cl. G01L 1/24; F21V 8/00

(52) U.S. Cl. CPC G01L 1/247; G02B 6/0043

(57) ABSTRACT

A sensing module including a photosensitive circuit board, a light source structure, a light manipulation sheet and a light shielding sheet is provided. The photosensitive circuit board is provided with a plurality of photosensitive devices. The light source structure is disposed on one side of a photosensitive surface of each of the photosensitive devices. The light manipulation sheet is disposed between the photosensitive circuit board and the light source structure, and includes a substrate and a plurality of optical microstructures. The optical microstructures are disposed on a substrate surface of the substrate facing the light source structure. The light shielding sheet is disposed on one side of the light source structure facing away from the light manipulation sheet. The light shielding sheet is adapted to receive external force and press the light manipulation sheet through the light source structure to deform the plurality of optical microstructures.

### CROSS-REFERENCE TO RELATED APPLICATION

This application claims the priority benefit of China application serial no. 202411231989.7, filed on Sep. 4, 2024. The entirety of the above-mentioned patent application is hereby incorporated by reference herein and made a part of this specification.

### BACKGROUND

### Technical Field

The invention relates to a sensing technology, and more particularly, to a sensing module.

### Description of Related Art

With the advancement of artificial intelligence technology and various sensing technologies, the development of consumer, caregiving or industrial robots has made remarkable progress in recent years. Among the robots' sensory capabilities, tactile sensing has gradually emerged as an important sensing ability alongside vision and hearing. For example, in situations with poor visibility or blind spots, robots can utilize tactile sensing to perceive surrounding objects, allowing them quickly stop their movement or take appropriate action, which enhances the precision of robot operations and helps avoid collisions that may cause harm to nearby personnel or objects.

Generally speaking, tactile perception is mostly achieved by pressure sensing technology, and existing pressure sensing technologies less susceptible to external environmental factors (such as temperature, magnetic field, water, dust, electromagnetic waves, vibration, etc.) can be roughly classified into piezoresistive, pneumatic and optical types. Among them, optical pressure sensing technology not only has the potential to achieve large-area sensing with a simpler module structure, but also has better reliability in sensing capabilities. However, research and development on large-area optical multi-dimensional pressure sensing technology is still relatively limited.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one or a portion of or all of the objects or other objects, an embodiment of the invention provides a sensing module that includes a photosensitive circuit board, a light source structure, a light manipulation sheet and a light shielding sheet. The photosensitive circuit board is provided with a plurality of photosensitive devices. The light source structure is disposed on one side of a photosensitive surface of each of the photosensitive devices. The light manipulation sheet is disposed between the photosensitive circuit board and the light source structure, and includes a substrate and a plurality of optical microstructures. The optical microstructures are disposed on a substrate surface of the substrate facing the light source structure. The light shielding sheet is disposed on one side of the light source structure facing away from the light manipulation sheet. The light shielding sheet is adapted to receive an external force and press the light manipulation sheet through the light source structure to deform the plurality of optical microstructures.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a sensing module according to a first embodiment of the invention.

FIG. 2 is an enlarged schematic view of the light source structure of FIG. 1.

FIG. 3 is a schematic top view of a light source structure of FIG. 1.

FIG. 4 is a schematic top view of a light manipulation sheet of FIG. 1.

FIG. 5 is a schematic cross-sectional view of the sensing module of FIG. 1 when subjected to an external force.

FIG. 6 is a distribution diagram of the light pattern measured by the photosensitive circuit board of FIG. 1 when the sensing module is not subject to the external force and when it is subject to the external force.

FIG. 7. is a schematic cross-sectional view of a sensing module according to a second embodiment of the invention.

FIG. 8 is a schematic cross-sectional view of the sensing module of FIG. 7 when subjected to an external force.

FIG. 9 is a schematic cross-sectional view of a sensing module according to a third embodiment of the invention.

FIG. 10 is a schematic bottom view of a shear force sensing layer of FIG. 9.

FIG. 11 is a schematic cross-sectional view of the shear force sensing layer of FIG. 10.

FIG. 12 is a schematic bottom view of the shear force sensing layer of FIG. 9 when subjected to an external force.

FIG. 13 is a schematic cross-sectional view of the shear force sensing layer of FIG. 10 when subjected to an external force.

FIG. 14 is a schematic cross-sectional view of a sensing module according to a fourth embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

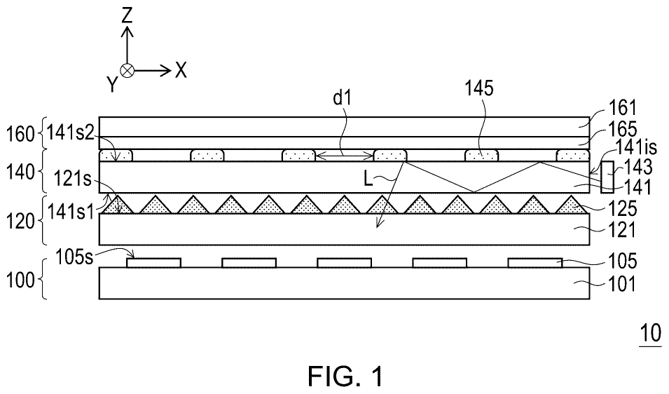

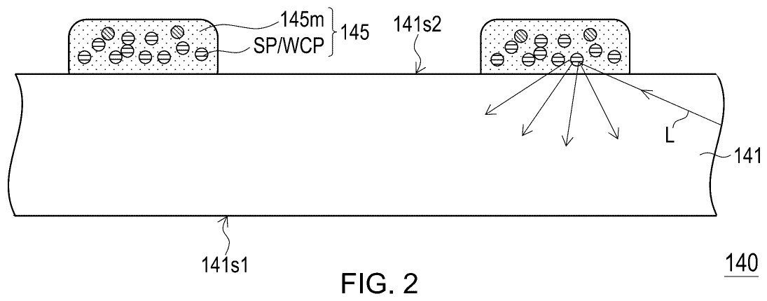

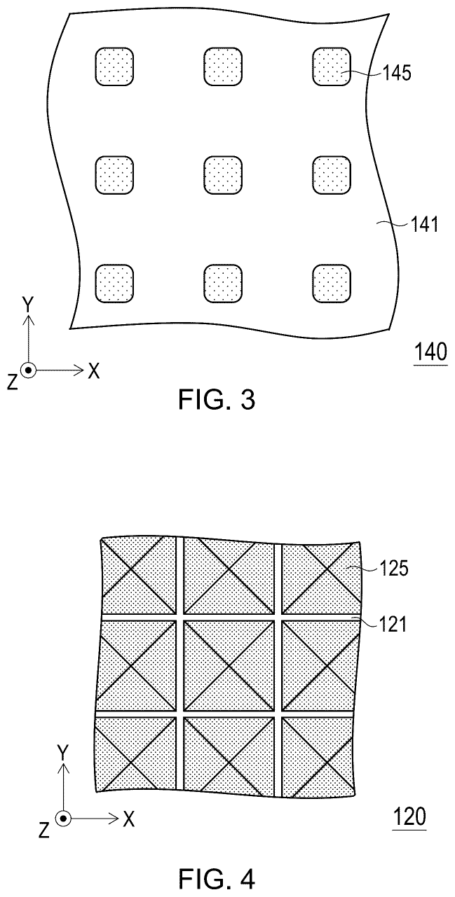

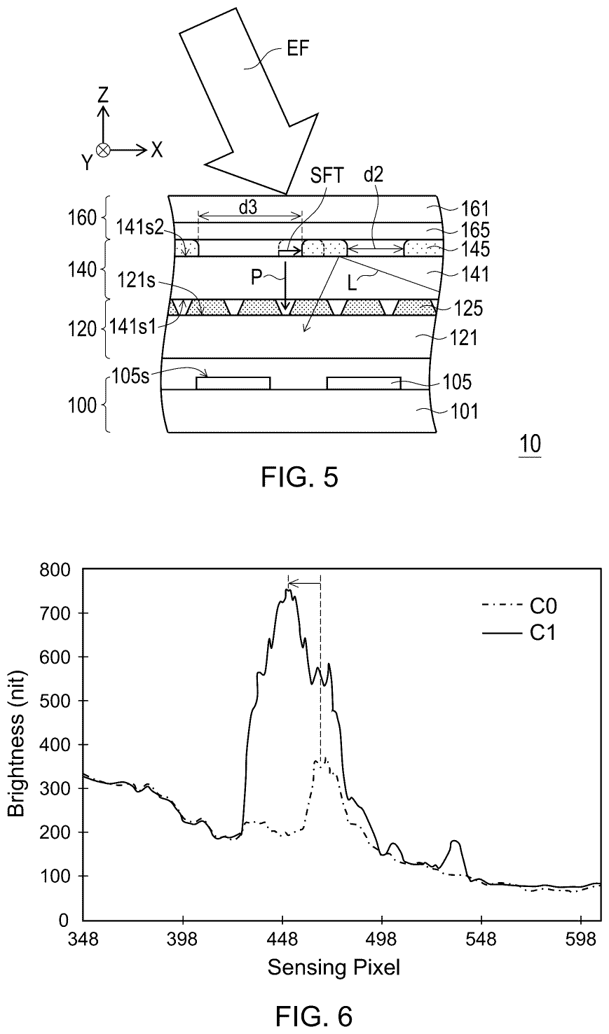

FIG. 1 is a schematic cross-sectional view of a sensing module according to a first embodiment of the invention. FIG. 2 is an enlarged schematic view of the light source structure of FIG. 1. FIG. 3 is a schematic top view of a light source structure of FIG. 1. FIG. 4 is a schematic top view of a light manipulation sheet of FIG. 1. FIG. 5 is a schematic cross-sectional view of the sensing module of FIG. 1 when subjected to an external force. FIG. 6 is a distribution diagram of the light pattern measured by the photosensitive circuit board of FIG. 1 when the sensing module is not subject to the external force and when it is subject to the external force.

Referring to FIG. 1, a sensing module 10 includes a photosensitive circuit board 100, a light manipulation sheet 120 and a light source structure 140. The photosensitive circuit board 100 includes a circuit board 101 and a plurality of photosensitive devices 105. The photosensitive device 105 is, for example, a photodiode, but the invention is not limited thereto. The circuit board 101 may be made of rigid or flexible board material. In the embodiment, the photosensitive devices 105 may be arranged in an array on the circuit board 101 and are each electrically connected to the circuit board 101. For example, the photosensitive devices 105 may be arranged in multiple rows and columns along a direction X and a direction Y, respectively, and constitute a plurality of photosensitive pixels of the photosensitive circuit board 100. In the embodiment, the direction X may be selectively perpendicular to the direction Y, but the invention is not limited thereto.

The light source structure 140 is disposed on one side of a photosensitive surface 105s of each of the plurality of photosensitive devices 105, and the light manipulation sheet 120 is disposed between the photosensitive circuit board 100 and the light source structure 140. In the embodiment, the light source structure 140 includes a flexible light guide plate 141 and a light source 143. The material of the flexible light guide plate 141 includes, for example, silicone, polydimethylsiloxane (PDMS), polyurethane (PU), or other elastic and stretchable materials. The flexible light guide plate 141 has a light incident surface 141is and a first surface 141sl and a second surface 141s2 connected to the light incident surface 141is and facing each other. The first surface 141sl faces the light manipulation sheet 120.

The light source 143 is disposed on one side of the light incident surface 141is of the flexible light guide plate 141 and is adapted to emit multiple light rays L toward the light incident surface 141is of the flexible light guide plate 141. The light rays L are adapted to be transmitted in the flexible light guide plate 141 and are emitted from the first surface 141s1. The light source 143 is, for example, a light bar or a light panel provided with a plurality of light emitting diodes (LEDs), but the invention is not limited thereto. In other embodiments, the light source may be a combination of a laser diode and a light guide element (such as an optical fiber), where the light guide element is used to guide the laser emitted by the laser diode into the flexible light guide plate 141. In order to expand the light, a diffusion lens or a diffusion mirror may be provided on one side of a light emitting surface of the light source, but the invention is not limited thereto.

Referring to FIG. 1, FIG. 2 and FIG. 3, in the embodiment, a plurality of scattering microstructures 145 are provided on the second surface 141s2 of the flexible light guide plate 141. The scattering microstructures 145 may be spaced apart on the second surface 141s2 along at least two directions that intersect with each other. For example, the scattering microstructures 145 may be arranged in multiple rows and columns spaced apart along the direction X and the direction Y. Through the scattering effect of the scattering microstructure 145, the light L transmitted in the flexible light guide plate 141 can be scattered by the scattering microstructure 145 to increase the angular range of light emitted from the first surface 141s1.

For example, in the embodiment, the scattering microstructure 145 includes a base 145m and a plurality of scattering particles SP or a plurality of wavelength conversion particles WCP dispersed in the base 145m. The material of the base 145m may include silicone or UV glue. The material of the scattering particles SP may include titanium dioxide, or other materials with scattering or reflective capabilities. The material of the wavelength conversion particle WCP may include fluorescent materials, phosphorescent materials, quantum dot materials, or other materials suitable for absorbing short-wavelength light (such as blue light or ultraviolet light) and emitting long-wavelength light (such as yellow light).

In the embodiment, the scattering microstructure 145 is, for example, a convex structure protruding from the second surface 141s2, but the invention is not limited thereto. In other embodiments, the scattering microstructure may be a recessed structure recessed from the second surface 141s2 toward the interior of the flexible light guide plate 141. It should be noted that since the flexible light guide plate 141 has elasticity and stretchability, a distance between at least two adjacent ones of the plurality of scattering microstructures 145 on the second surface 141s2 is adapted to be changed by an external force. Therefore, by detecting the change in the aforementioned distance, the direction and magnitude of the external force can be obtained.

Referring to FIG. 1 and FIG. 4, on the other hand, the light manipulation sheet 120 includes a substrate 121 and a plurality of optical microstructures 125, and the optical microstructures 125 are disposed on a substrate surface 121s of the substrate 121 facing the light source structure 140. For example, the optical microstructures 125 may be spaced apart along at least two directions (e.g., the direction X and the direction Y) that are parallel to the substrate surface 121s and intersecting each other, but the invention is not limited thereto. The material of the light manipulation sheet 120 may include silicone, polydimethylsiloxane (PDMS), polyurethane (PU), or other elastic and stretchable materials.

The multiple light rays L transmitted in the flexible light guide plate 141 are emitted from the first surface 141sl and then transmitted to the light manipulation sheet 120, and the optical microstructures 125 of the light manipulation sheet 120 is adapted to direct these light rays L to the plurality of photosensitive devices 105 on the photosensitive circuit board 100. More specifically, the light pattern distribution (e.g., the light intensity distribution on a plane parallel to the direction X and the direction Y) of the light L emitted by the light source structure 140 toward the manipulation sheet 120 depends on the configuration (such as structural appearance and location) of the plurality of optical microstructures 125 on the light manipulation sheet 120.

In the embodiment, the optical microstructure 125 may be a quadrangular pyramid protruding from the substrate surface 121s. However, the invention is not limited thereto. According to the required light pattern distribution, the structural appearance of the optical microstructure 125 may be changed to other suitable cones, cylinders or spheres. Since the substrate 121 and the plurality of optical microstructures 125 of the light manipulation sheet 120 have elasticity and stretchability, an external force applied in a normal direction of the substrate surface 121s (e.g., the direction Z) can cause deformation of the optical microstructures 125, thereby changing the intensity of the light L after passing through the compressed optical microstructure 125. In other words, by detecting the changes in the peak position of the light pattern and the light intensity of the light L, the magnitude and direction of the external force can be obtained.

In order to prevent external light from entering the sensing module 10 and affecting the reliability of the sensing results, the sensing module 10 is further provided with a light shielding sheet 160. The light shielding sheet 160 is disposed on one side of the light source structure 140 facing away from the light manipulation sheet 120. The light shielding sheet 160 includes a substrate 161. In the embodiment, in order to increase the light energy utilization rate of the light source structure 140, the light shielding sheet 160 may be further provided with a reflective layer 165 on one side of the substrate 161 facing the light source structure 140. The material of the substrate 161 may include silicone, polydimethylsiloxane (PDMS), polyurethane (PU), or other elastic and stretchable materials. In some embodiments, the light shielding sheet may not be provided with the reflective layer 165, and its material must possess opaque properties, such as doping light-absorbing particles or reflective particles in the substrate 161, but the invention is not limited thereto.

In particular, the light shielding sheet 160 disposed on one side of the light source structure 140 facing away from the light manipulation sheet 120 can also prevent the scattering microstructures 145 on the flexible light guide plate 141 from being damaged by direct contact with external forces. That is, the light shielding sheet 160 serves a protective function for the light source structure 140.

Referring to FIG. 1 and FIG. 5, in the embodiment, the sensing module 10 is adapted to sense the applied pressure and direction of an external force EF, that is, the sensing module 10 may be a pressure sensing module. The pressure sensing principle of the sensing module 10 will be exemplarily described below.

When the sensing module 10 is not subjected to the external force EF, any two adjacent ones of the plurality of scattering microstructures 145 of the light source structure 140, arranged along the direction X or the direction Y, are spaced apart by a distance d1 (as shown in FIG. 1). When the sensing module 10 is subjected to the external force EF as shown in FIG. 5, the distance between at least two adjacent ones of the scattering microstructures 145 will be changed by the external force EF. For example, one scattering microstructure 145 shown in FIG. 5 moves closer to another scattering microstructure 145 on its right side (i.e., the distance d2 between them becomes smaller than the aforementioned distance d1), and moves away from still another scattering microstructure 145 on its left side (i.e., the distance d3 between them becomes greater than the aforementioned distance d1). That is, the middle scattering microstructure 145 in FIG. 5 will undergo a displacement SFT along the direction X.

In addition, when the external force EF is applied to the light shielding sheet 160 of the sensing module 10, a downward pressure P (or a normal force) is also generated along the normal direction (e.g., the reverse direction of the direction Z) of the first surface 141s1. The downward pressure P will press the light manipulation sheet 120 through the light source structure 140, causing the plurality of optical microstructures 125 of the light manipulation sheet 120 to deform (as shown in FIG. 5). When the light L passes through the deformed optical microstructures 125, its optical path will change, thereby affecting the light pattern and intensity distribution of the light L transmitted to the photosensitive circuit board 100. In the embodiment, the deformation of the optical microstructures 125 is caused by the downward pressure P directly pressing the optical microstructures 125 through the first surface 141sl of the flexible light guide plate 141, but the invention is not limited thereto.

Referring to FIG. 5 and FIG. 6, the curve C0 illustrates the brightness distribution of the light L detected by a plurality of photosensitive pixels (i.e., photosensitive devices 105) arranged along the direction X on the photosensitive circuit board 100 when the sensing module 10 is not subjected to the external force EF. The curve C1 illustrates the brightness distribution of the light L detected by the photosensitive circuit board 100 along the direction X when the sensing module 10 is subjected to the external force EF. By comparing the curve C0 with the curve C1, it can be seen that when the external force EF is applied to the sensing module 10, the brightness peak and peak position detected by the photosensitive circuit board 100 differ from those detected when the sensing module 10 is not subjected to the external force EF. That is, the two curves in FIG. 6 illustrate the change in the light pattern distribution detected by the photosensitive circuit board 100 when the external force EF is applied to the sensing module 10.

Therefore, when the sensing module 10 is subjected to the external force EF, the magnitude of the downward pressure P applied to the sensing module 10 along a normal direction (e.g., the reverse direction of the direction Z) of the first surface 141sl can be obtained by analyzing the degree of change in the light pattern distribution detected by the photosensitive circuit board 100. By detecting the peak position of the light pattern, the moving direction of the scattering microstructure 145 can be identified, which allows for determining the direction of a horizontal shear force (or lateral force) component of the external force EF.

In particular, through the stacked structural design of the aforementioned light manipulation sheet 120, light source structure 140 and photosensitive circuit board 100, the sensing module 10 can meet the demand for large-area pressure sensing at a lower cost and achieve more reliable sensing results.

Some other embodiments are provided below to describe the invention in detail, where the same reference numerals denote the same or like components, and descriptions of the same technical contents are omitted. The aforementioned embodiment may be referred for descriptions of the omitted parts, and detailed descriptions thereof are not repeated in the following embodiment.

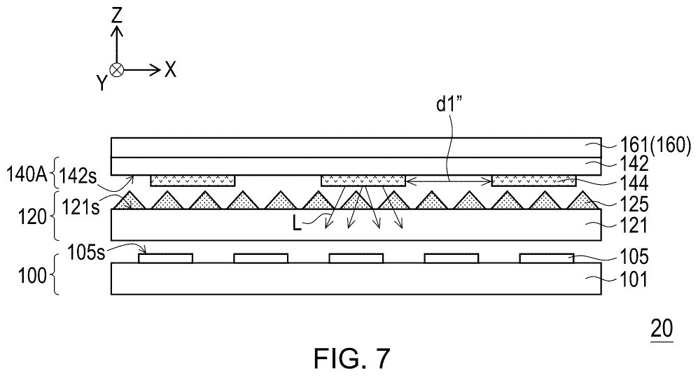

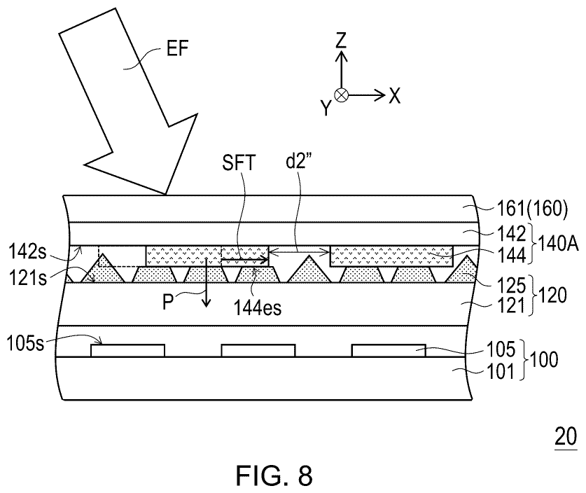

FIG. 7. is a schematic cross-sectional view of a sensing module according to a second embodiment of the invention. FIG. 8 is a schematic cross-sectional view of the sensing module of FIG. 7 when subjected to an external force. Referring to FIG. 7, the main difference between a sensing module 20 of the embodiment and the sensing module 10 of FIG. 1 lies in that the design of the light source structure is different. On the other hand, the light shielding sheet 160 of the embodiment is not provided with the reflective layer 165 as shown in FIG. 1 on one side of the substrate 161 facing the light source structure 140A.

Specifically, in the embodiment, the light source structure 140A of the sensing module 20 may include a flexible circuit board 142 and a plurality of light emitting devices 144, and the light emitting devices 144 are spaced apart along at least two directions (e.g., the direction X and the direction Y) intersecting each other on one side of a surface 142s of the flexible circuit board 142 facing the light manipulation sheet 120. That is, the light emitting devices 144 of the embodiment may be arranged in an array on the surface 142s of the flexible circuit board 142, and overlap the plurality of optical microstructures 125 on the light manipulation sheet 120 along a normal direction of the surface 142s.

In the embodiment, the light emitting device 144 is, for example, a light emitting diode with a wide light emission angle range, and is used to emit light L directly toward the light manipulation sheet 120. That is, the light L emitted by the light emitting device 144 of the embodiment is directed toward the light manipulation sheet 120 without being transmitted through the flexible light guide plate 141 as shown in FIG. 1. It should be noted that since the flexible circuit board 142 has elasticity and stretchability, the distance between at least two adjacent ones of the plurality of light emitting devices 144 on the surface 142s is adapted to be changed by an external force. Therefore, by detecting the change in the aforementioned distance, the direction and magnitude of the external force can be obtained.

The pressure sensing principle of the sensing module 20 will be exemplarily described below. Referring to FIG. 7 and FIG. 8, when the sensing module 20 is not subjected to an external force EF, any two adjacent ones of the plurality of light emitting devices 144 of the light source structure 140A, arranged along the direction X or the direction Y, are spaced apart by a distance d1″ (as shown in FIG. 7). When the sensing module 20 is subjected to the external force EF as shown in FIG. 8, the distance between at least two adjacent ones of the light emitting devices 144 will be changed by the external force EF. For example, one light emitting device 144 shown in FIG. 8 moves closer to another light emitting device 144 on its right side (i.e., the distance d2″ between them becomes smaller than the aforementioned distance d1″), and moves away from still another light emitting device 144 not shown on its left side (i.e., the distance between them becomes greater than the aforementioned distance d1″). That is, the middle light emitting device 144 in FIG. 8 will undergo a displacement SFT along the direction X.

In addition, when the external force EF is applied to the light shielding sheet 160 of the sensing module 20, a downward pressure P is also generated along the normal direction (e.g., the reverse direction of the direction Z) of the surface 142s of the flexible circuit board 142. The downward pressure P will press the light manipulation sheet 120 through the light source structure 140A, causing the plurality of optical microstructures 125 of the light manipulation sheet 120 to deform (as shown in FIG. 8). When the light L passes through the deformed optical microstructure 125, its optical path will change, thereby affecting the light pattern and intensity distribution of the light L transmitted to the photosensitive circuit board 100. In the embodiment, the deformation of the optical microstructures 125 is caused by the downward pressure P directly pressing the optical microstructures 125 through a light emitting surface 144es of the light emitting device 144, but the invention is not limited thereto.

When the sensing module 20 is subjected to the external force EF, the magnitude of the downward pressure P applied to the sensing module 20 along the normal direction of the surface 142s can be obtained by analyzing the degree of the change in the light pattern distribution. By detection the peak position of the light pattern, the moving direction of the light emitting device 144 can be identified, which allows for determining the direction of a horizontal shear force (or lateral force) component of the external force EF. On the other hand, through the stacked structural design of the aforementioned light manipulation sheet 120, light source structure 140A and photosensitive circuit board 100, the sensing module 20 can meet the demand for large-area pressure sensing at a lower cost and achieve more reliable sensing results.

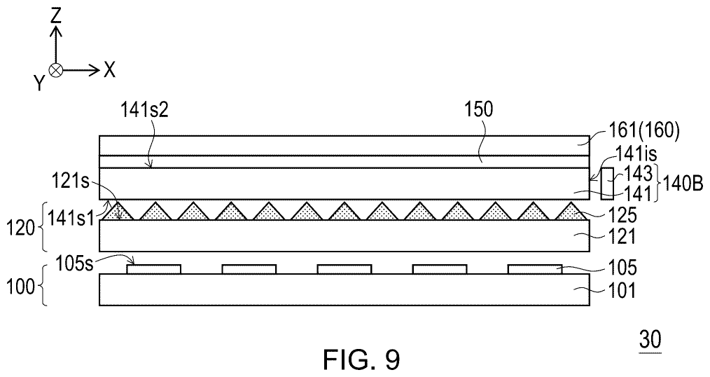

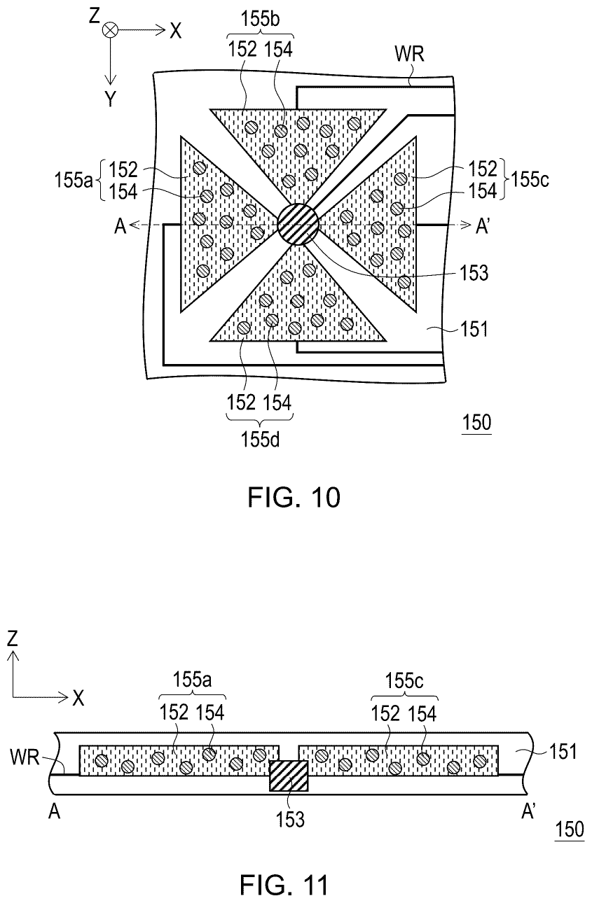

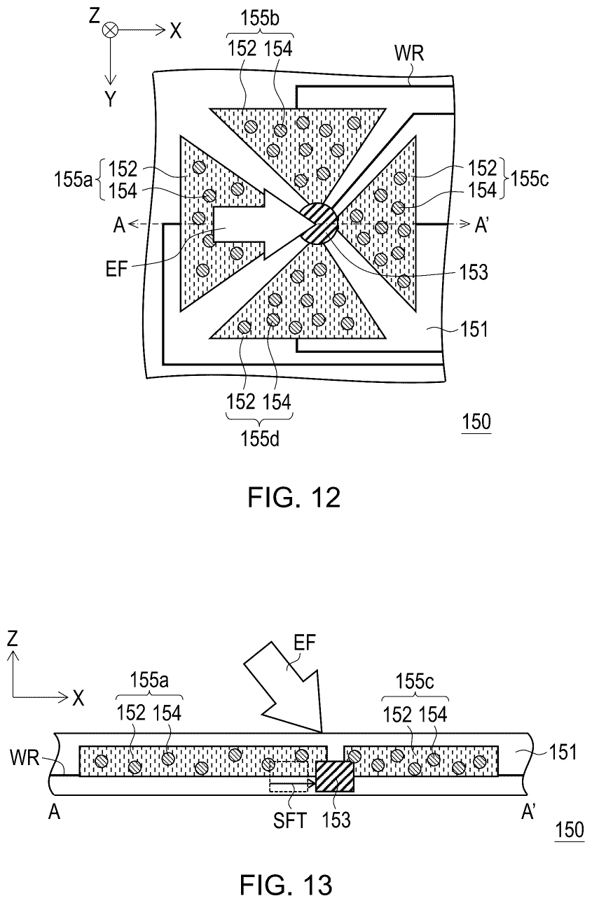

FIG. 9 is a schematic cross-sectional view of a sensing module according to a third embodiment of the invention. FIG. 10 is a schematic bottom view of a shear force sensing layer of FIG. 9. FIG. 11 is a schematic cross-sectional view of the shear force sensing layer of FIG. 10. FIG. 12 is a schematic bottom view of the shear force sensing layer of FIG. 9 when subjected to an external force. FIG. 13 is a schematic cross-sectional view of the shear force sensing layer of FIG. 10 when subjected to an external force. FIG. 13 corresponding to the section line A-A′ in FIG. 12.

Referring to FIG. 9, FIG. 10 and FIG. 11, in the embodiment, the sensing module 30 replaces the plurality of scattering microstructures 145 in FIG. 1 with a shear force sensing layer 150, meaning that the light source structure 140B of the embodiment is not provided with the plurality of scattering microstructures 145 of FIG. 1. On the other hand, the light shielding sheet 160 of the embodiment is not provided with the reflective layer 165 as shown in FIG. 1 on one side of the substrate 161 facing the light source structure 140B.

For example, the shear force sensing layer 150 may be disposed between the light shielding sheet 160 and the light source structure 140B, and includes a base 151, a conductive block 153, and a plurality of conductive polymer patterns connecting the conductive block 153. The conductive block 153 and the plurality of conductive polymer patterns are covered by the base 151. The material of the base 151 may include a non-conductive flexible polymer material. The material of the conductive block 153 may include copper or other suitable high conductivity materials, such as graphite. In the embodiment, a conductive polymer pattern 155a (a first conductive polymer pattern) and a conductive polymer pattern 155c (a third conductive polymer patterns) may be respectively provided on two opposite sides of the conductive block 153 along the direction X (a first direction), and a conductive polymer pattern 155b (a second conductive polymer pattern) and a conductive polymer pattern 155d (a fourth conductive polymer pattern) may be respectively provided on two opposite sides of the conductive block 153 along the direction Y (a second direction).

Each of the conductive polymer patterns includes an elastic polymer pattern 152 and a plurality of conductive particles 154 dispersed in the elastic polymer pattern 152. The material of the elastic polymer pattern may include flexible polymer materials, and the material of the conductive particles 154 may include nano-silver, carbon nanotubes, etc. It should be noted first that each conductive polymer pattern has a first end connected to the conductive block 153 and a second end connected to the wire WR. By measuring the change in resistance between the first end and the second end of the conductive polymer pattern, the shear force (or lateral force) component generated by the external force on the sensing module 30 can be detected. That is, the conductive polymer pattern in the embodiment is a design composed of piezoresistive sensing materials. In the embodiment, the conductive block 153, the conductive polymer pattern 155a, the conductive polymer pattern 155b, the conductive polymer pattern 155c and the conductive polymer pattern 155d may constitute a sensing unit of the shear force sensing layer 150, and the shear force sensing layer 150 may be provided with a plurality of the aforementioned sensing units.

Referring to FIG. 9, FIG. 12 and FIG. 13, for example, when an external force EF is applied to the sensing module 30, the conductive block 153 of the shear force sensing layer 150 will experience a displacement SFT due to the horizontal shear force generated in the direction X by the external force EF. At the same time, the length of the conductive polymer pattern 155a located on one side of the conductive block 153 along the direction X will increase due to the stretching of the conductive block 153, and the length of the conductive polymer pattern 155c located on the other side of the conductive block 153 will decrease due to the compression of the conductive block 153. Therefore, the resistance between the first end and the second end of the conductive polymer pattern 155a will increase due to the reduced distribution density of the conductive particles 154, while the resistance between the first end and the second end of the conductive polymer pattern 155c will decrease due to the increased distribution density of the conductive particles 154.

In other words, the shear force sensing layer 150 in the embodiment detects the direction and magnitude of the horizontal shear force generated by the external force EF on the sensing module 30 by measuring the change in resistance between the first end and the second end of the conductive polymer pattern. Since the sensing principles of the conductive polymer pattern 155b and the conductive polymer pattern 155d of the shear force sensing layer 150 for the horizontal shear force along the direction Y are similar to those of the conductive polymer pattern 155a and the conductive polymer pattern 155c for the horizontal shear force along the direction X, further elaboration will not be repeated here. It should be noted that the number and structural appearance of the conductive polymer patterns connected to the conductive block 153 may be adjusted according to actual application requirements, and are not limited by the present invention.

In another embodiment not shown, the aforementioned conductive polymer patterns can also be used to replace the optical microstructures 125 on the light manipulation sheet 120 to sense the downward pressure P generated by the external force EF shown in FIG. 5.

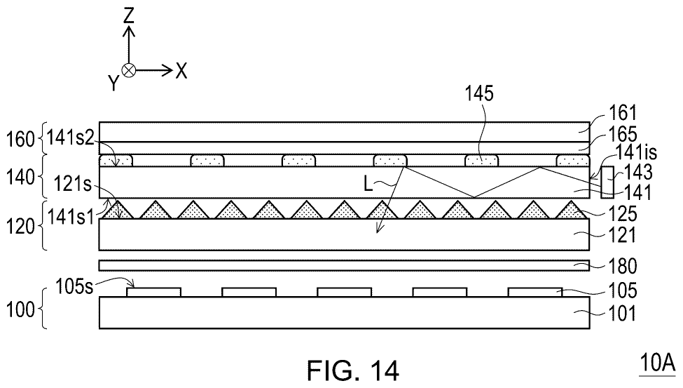

FIG. 14 is a schematic cross-sectional view of a sensing module according to a fourth embodiment of the invention. Referring to FIG. 14, compared to the sensing module 10 in FIG. 1, a sensing module 10A of the embodiment may further include a filter layer 180 disposed between the photosensitive circuit board 100 and the light source structure 140. More specifically, the filter layer 180 may be disposed between the light manipulation sheet 120 and the photosensitive circuit board 100, but the invention is not limited thereto. In other embodiments, the filter layer 180 may also be disposed between the light source structure 140 and the light manipulation sheet 120. The arrangement of the filter layer 180 can block light of unexpected wavelengths from entering the photosensitive devices 105, thereby improving the signal-to-noise ratio of the photosensitive circuit board 100.

To sum up, in a sensing module according to an embodiment of the invention, the light manipulation sheet located between the light source structure and the photosensitive circuit board is provided with a plurality of optical microstructures, and the optical microstructures are disposed facing the light source structure. An external force applied to the light shielding sheet can press the light manipulation sheet through the light source structure, causing the optical microstructures to deform, which changes the light pattern and intensity distribution detected by the photosensitive circuit board. The degree of change in light intensity is used to obtain the pressure applied to the sensing module. The direction and magnitude of lateral force can be assessed by detecting the peak position of the light pattern. The stacked structural design of the light manipulation sheet, the light source structure and the photosensitive circuit board enables the sensing module to meet the demand for large-area sensing at a lower cost and achieve more reliable sensing results.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A sensing module, comprising:
a photosensitive circuit board, provided with a plurality of photosensitive devices;
a light source structure, disposed on one side of a photosensitive surface of each of the plurality of photosensitive devices;
a light manipulation sheet, disposed between the photosensitive circuit board and the light source structure, and including a substrate and a plurality of optical microstructures, wherein the plurality of optical microstructures are disposed on a substrate surface of the substrate facing the light source structure; and
a light shielding sheet, disposed on one side of the light source structure facing away from the light manipulation sheet, wherein the light shielding sheet is adapted to receive an external force and press the light manipulation sheet through the light source structure to deform the plurality of optical microstructures.

2. The sensing module according to claim 1, wherein the light shielding sheet is provided with a reflective layer on one side facing the light source structure.

3. The sensing module according to claim 1, wherein the plurality of optical microstructures are spaced apart along at least two directions parallel to the substrate surface and intersecting each other.

4. The sensing module according to claim 1, wherein the light source structure includes:
a flexible light guide plate, having a light incident surface and a first surface and a second surface connected to the light incident surface and facing each other, wherein the first surface faces the light manipulation sheet, and the second surface is provided with a plurality of scattering microstructures; and
a light source, disposed on one side of the light incident surface of the flexible light guide plate.

5. The sensing module according to claim 4, wherein the plurality of scattering microstructures are spaced apart on the second surface along at least two directions intersecting each other, and a distance between at least two adjacent ones of the plurality of scattering microstructures is adapted to be changed by the external force.

6. The sensing module according to claim 4, wherein the plurality of scattering microstructures include a base and a plurality of scattering particles or a plurality of wavelength conversion particles dispersed in the base.

7. The sensing module according to claim 1, wherein the light source structure includes:
a flexible circuit board; and
a plurality of light emitting devices, spaced apart on one side of the flexible circuit board facing the light manipulation sheet along at least two directions intersecting each other.

8. The sensing module according to claim 7, wherein a distance between at least two adjacent ones of the plurality of light emitting devices is adapted to be changed by the external force.

9. The sensing module according to claim 1, further comprising:
a shear force sensing layer, disposed between the light shielding sheet and the light source structure, wherein the shear force sensing layer includes a conductive block and a first conductive polymer pattern and a second conductive polymer pattern connecting the conductive block, the first conductive polymer pattern is disposed on one side of the conductive block along a first direction, the second conductive polymer pattern is disposed on one side of the conductive block along a second direction, and the first direction intersects the second direction.

10. The sensing module according to claim 9, wherein the shear force sensing layer further includes a third conductive polymer pattern and a fourth conductive polymer pattern connecting the conductive block, the third conductive polymer pattern is disposed on the other side of the conductive block along the first direction, and the fourth conductive polymer pattern is disposed on the other side of the conductive block along the second direction.

11. The sensing module according to claim 9, wherein the first conductive polymer pattern and the second conductive polymer pattern each include an elastic polymer pattern and a plurality of conductive particles dispersed in the elastic polymer pattern.

12. The sensing module according to claim 1, further comprising:
a filter layer, disposed between the photosensitive circuit board and the light source structure.
